(19) United States
(12) Patent Application Publication
(10) Pub. No.: US 2020/0073280 A1
(43) Pub. Date: Mar. 5, 2020

(54) DEVELOPER SUPPLY CONTAINER

(71) Applicant: CANON KABUSHIKI KAISHA, Tokyo (JP)

(72) Inventors: Masataka Fumoto, Tokyo (JP); Dai Kanai, Abiko-shi (JP); Kiyoshi Oyama, Tokyo (JP)

(21) Appl. No.: 16/551,982

(22) Filed: Aug. 27, 2019

(30) Foreign Application Priority Data
Aug. 30, 2018 (JP) 2018-162136

(51) Int. Cl. G03G 15/08

(52) U.S. Cl. CPC G03G 15/0881

(57) ABSTRACT

A developer supply container includes an accommodating portion, a discharging portion, a sealing member, a first restricting portion, and a second restricting portion positioned upstream of the first restricting portion with respect to an inserting direction of the accommodating portion. The seal member is provided between the first restricting portion and the second restricting portion with respect to a rotational axis direction of the accommodating portion.

### FIELD OF THE INVENTION AND RELATED ART

The present invention relates to a developer supply container suitably usable with an image forming apparatus of an electrophotographic type, such as a primer, a copying machine, a facsimile machine, a multifunction machine and so on.

In an image forming apparatus of the electrophotographic type, an image is formed using the developer, and the developer is consumed in accordance with the image forming operation. Therefore, the image forming apparatus is equipped with a developer supply device for supplying the developer into the image forming apparatus. Japanese Laid-Open Patent Application 2006-308781 discloses a developer supplying apparatus to which a developer supply container containing the developer to be supplied into the image forming apparatus is detachably mountable. The developer supply container comprises a discharging chamber (discharging portion) provided with a discharge opening, and an accommodating chamber (accommodating portion) capable of accommodating the developer, the accommodating chamber being rotatable relative to the discharging portion. The accommodating portion is engaged with the discharging portion with a gap in order to permit the rotation (loose fitting), and therefore, a sealing member in the form of a ring is provided to prevent leakage of the developer through the gap to the outside of the developer supply container.

When the loose fitting is used between the accommodating portion and the discharging portion, a whirling motion tends to occur in which the accommodating portion moving in the radial direction crossing with the rotational axis direction, due to variations in the parts of the device and variation in the rotational load, or the like. If this occurs, there is a liability that the developer leaks through the contact portion between the accommodating portion and the sealing member. For this reason, an elastic sealing member is used, and the sealing member is compressed in the rotational axis direction by the discharging portion and the accommodating portion, so as to suppress the whirling motion of the accommodating portion. In addition, with the structure disclosed in the Japanese Laid-Open Patent Application (JP-A) 2006-308781, a contact surface of the sealing member in the discharging portion or the accommodating portion is slanted, so that a strong force is produced by the sealing member against the whirling motion during the rotation of the accommodating portion, in order to suppress the whirling motion.

When the loose fitting is used between the accommodating portion and the discharging portion, the accommodating portion may rotate with inclination in the radial direction relative to the discharging portion. For example, when a deviation in mounting position between the discharging portion and the accommodating portion is large and when the accommodating portion is rotated through a driving force transmission from an external driving source using a gear portion provided at the outer circumferential periphery of the accommodating portion (a radial force applied by the driving load), the accommodating portion may rotate with the inclination relative to the discharging portion. In the case of the developer supply container disclosed in the above-mentioned JP-A 2006-308781, when the accommodating portion rotates in an inclined state, the pressure applied in the rotational axis direction to the sealing member is not even over the circumference. Then, the sealing member may be locally deformed at the position where the pressure is large. If this occurs, the elasticity of the sealing member at such a position is lost, with the result that the deformation may increase to such an extent that a gap is produced between the accommodating portion and the sealing member depending on use, and thus the developer leaked out of the accommodating portion through the gap in some instances.

Accordingly, it is an object of the present invention to provide a developer supply container in which a whirling motion of an accommodating portion is suppressed by a sealing member, and that deformation of the sealing member attributable to rotation of the accommodating portion with an inclination relative to a discharging portion is suppressed.

### SUMMARY OF THE INVENTION

According to an aspect of the present invention, there is provided a developer supply container mountable in and dismountable from a developer supply device, the developer supply container comprising: an accommodating portion including one end portion provided with an opening, wherein a developer accommodated in the accommodating portion is fed toward the one end portion by rotation of the accommodating portion; a discharging portion including a receiving portion into which the one end portion of the accommodating portion is inserted so as to be rotatable relative to the accommodating portion, and a discharge opening configured to discharge the developer supplied through the opening of the accommodating portion, wherein the accommodating portion is nonrotatably mounted to the developer supply device; a sealing member configured to seal a space between the one end portion and the receiving portion by being elastically compressed; a first restricting portion provided on the one end portion and configured to restrict movement of the accommodating portion in a radical direction crossing a rotational axis direction of the accommodating portion in contact with the receiving portion; and a second restricting portion contactable to the receiving portion on a side upstream of the first restricting portion with respect to an inserting direction of the one end portion and configured to restrict the movement of the accommodating portion in the radial direction, wherein the seal member is provided between the first restricting portion and the second restricting portion with respect to the rotational axis direction.

Further features of the present invention will become apparent from the following description of exemplary embodiments with reference to the attached drawings.

### BRIEF DESCRIPTION OF THE DRAWINGS

FIG. 1 is a sectional view of an image forming apparatus usable with a developer supply container according to an embodiment of the present invention.

FIG. 2 is a schematic view of a developing device.

Part (a) of FIG. 3 is a perspective view of an outer appearance of a mounting portion, and part (b) of FIG. 3 is a sectional view of the mounting portion.

FIG. 4 is an enlarged view illustrating the developer supply container and a developing supplying device,

Part (a) of FIG. 5 is a perspective view of an outer appearance of the developer supply container, and part (b) of FIG. 5 is a perspective sectional view of the developer supply container.

FIG. 6 is an enlarged perspective view of an accommodating portion according to a first embodiment of the present invention.

FIG. 7 is a perspective view of a flange portion in the first embodiment.

Part (a) of FIG. 8 is a partial view in a state in which a pump portion is expanded to the maximum usable limit, and part (b) of FIG. 8 is a partial view in a state in which the pump portion is contracted to the minimum usable limit.

Part (a) of FIG. 9 is a partial sectional view illustrating the mounting of a flange portion and the accommodating portion, in the first embodiment, and part (b) is a partial enlarged view illustrating the mounting of the flange portion and the accommodating portion, in the first embodiment.

FIG. 10 is a schematic view illustrating restriction of the accommodating portion relative to the flange portion, in the first embodiment.

FIG. 11 is a graph of comparison between the first embodiment and a conventional example in deformation of a sealing member.

FIG. 12 is an enlarged perspective view of an accommodating portion in a second embodiment of the present invention.

FIG. 13 is a perspective view of a flange portion in the second embodiment of the present invention.

Part (a) of FIG. 14 is a partial sectional view illustrating mounting of the flange portion and the accommodating portion, in the second embodiment of the present invention, and part (b) of FIG. 14 is a partial enlarged sectional view illustrating mounting of the flange portion and the accommodating portion.

### DESCRIPTION OF EMBODIMENTS

### First Embodiment

In the following, an image forming apparatus according to this embodiment will be described. First, a summary of the image forming apparatus will be described and then a developer supply device and a developer supply container which are mounted in this image forming apparatus will be described.

### (Image Forming Apparatus)

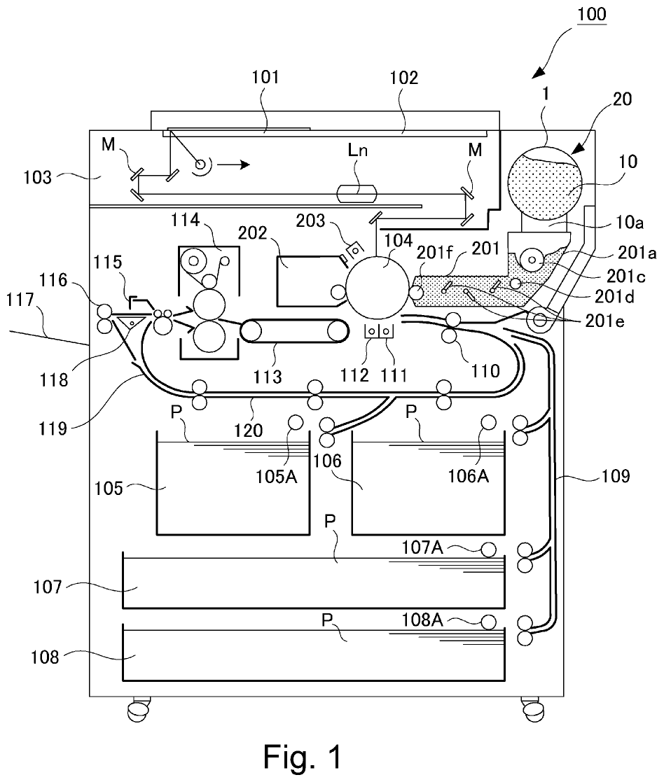

As the image forming apparatus in which the developer supply container is mountable in and dismountable from the developer supply device, the image forming apparatus employing an electrophotographic type will be described with reference to FIG. 1.

As shown in FIG. 1, an image forming apparatus 100 includes an original supporting platen glass 102, and an original 101 is placed on this original supporting platen glass 102. Then, an optical image depending on image information of the original 101 is formed on a photosensitive member 104 electrically charged uniformly by a charger 203 in advance, by a plurality of mirrors M and a lens Ln of an optical portion 103, whereby an electrostatic latent image is formed on the photosensitive member 104. This electrostatic latent image is visualized with toner (one component magnetic toner) as a developer (dry powder) by a dry developing device (one component developing device) 201a. That is, a toner image (developer image) is formed on the photosensitive member 104.

In the image forming apparatus 100, a plurality of cassettes 105-108 for accommodating recording materials (hereinafter referred to as sheets) are provided. Of these cassettes 105-108 in which sheets P are stacked, the sheet P is fed from either one of the cassettes selected on the basis of information or a size of the original 101 which are inputted by an operator through an operating portion (not shown) provided on the image forming apparatus 100. Here, as the recording material (sheet), it is not limited to a sheet (paper), but for example, an OHP sheet and the like can be appropriately used and selected.

Then, a single sheet P fed by either one of feeding and separation devices 105A-108A is fed to a registration roller pair 110 via a feeding portion 109. Then, this sheet P is conveyed to a transfer portion in synchronism with rotation of the photosensitive member 104 and scanning by the optical portion 103.

The transfer portion includes a transfer charger 111 and a separation charger 112. The transfer charger 111 and the separation charger 112 are provided opposed to the photosensitive member 104. The toner image formed on the photosensitive member 104 is transferred onto the sheet P by the transfer charger 111. Then, the sheet P on which the developer image (toner image) is transferred is separated from the photosensitive member 104by the separation charger 112.

Thereafter, the sheet P fed by a feeding portion 113 is heated and pressed in a fixing portion 114 and the developer image is fixed on the sheet P, and in the case of one-side copying, the sheet P passes through a discharging reverse portion 115 and is discharged to a discharge tray 117 by a discharging roller pair 116.

On the other hand, in the case of double-side copying, the sheet P passes through the discharging reverse portion 115, and a part of the sheet P is once discharged to an outside of the image forming apparatus 100 by the discharging roller pair 116. Thereafter, a trailing end of the sheet P passes through a flapper 118, and the sheet P is fed again in the image forming apparatus 100 by controlling the flapper 118 at timing when the sheet P is still nipped by the discharging roller pair 116 and by reversely rotating the discharging roller pair 116. Thereafter, the sheet P is fed to the registration roller pair 110 via re-feeding conveying portions 119 and 120, and then is fed along a path similar to the path in the case of the one-side copying and thus is discharged onto the discharge tray 117.

In the image forming apparatus 100 having the above-described constitution, around the photosensitive member 104, image forming process devices such as a developing device 201, a cleaner portion 202 and a primary charger 203 are provided. Incidentally, the developing device 201 develops the electrostatic latent image formed on the photosensitive member 104 by the optical portion 103 on the basis of the image information of the original 101, by depositing the developer on the electrostatic latent image. Further, the primary charger 203 electrically charges uniformly a photosensitive member surface in order to form a desired electrostatic latent image on the photosensitive member 104. The cleaner portion 202 removes the developer remaining on the photosensitive member 104.

### (Developing Device)

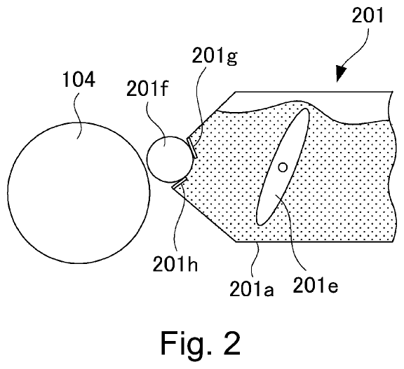

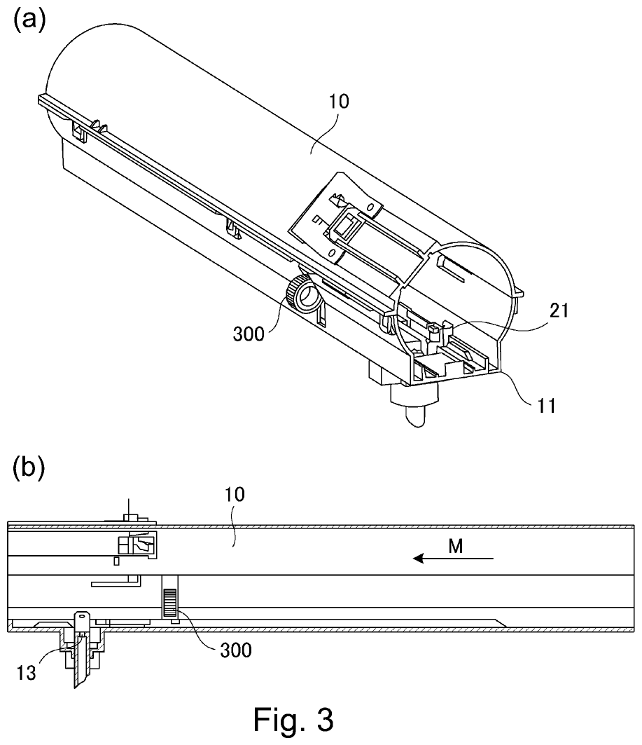

Next, the developing device 201 will be described with reference to FIGS. 1 and 2. As shown in FIGS. 1 and 2, the developing device 201 includes a developer container 201a, a developing roller 201f, a stirring member 201c and feeding members 201d and 201e. In the case of this embodiment, to the developing device 201, the above-described one component magnetic toner is supplied as the developer from a developer supply device 20 in which a developer supply container 1 described later is mounted. The developer supplied to the developing device 201 is stirred by the stirring member 201c and is sent to the developing roller 201f by the feeding members 201d and 201e, and then is supplied to the photosensitive member 104 by the developing roller 201f.

In the developing device 201, a developing blade 201g for regulating a coat amount of the developer on the developing roller 201f is provided in contact with the developing roller 201f. Further, in the developing device 201, a leakage-preventing sheet 201h is provided in contact with the developing roller 201f in order to prevent leakage of the developer from between the developing roller 201f and the developing container 201a.

In this embodiment, as the developer which should be supplied from the developer supply device 20, the one component magnetic toner is used, but the developer is not limited thereto. For example, a two component developing device in which development is carried out using a two component developer in which a magnetic carrier and non-magnetic toner are mixed with each other may also be used, and in that case, as the developer, the non-magnetic toner is supplied. In this case, a constitution in which as the developer, not only the non-magnetic toner but also the magnetic carrier are supplied in combination may also be employed.

### (Developer Supply Device)

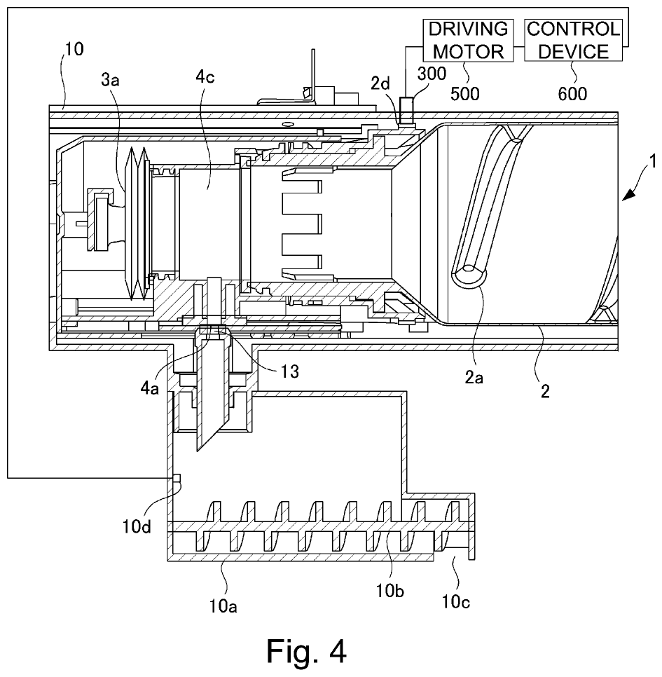

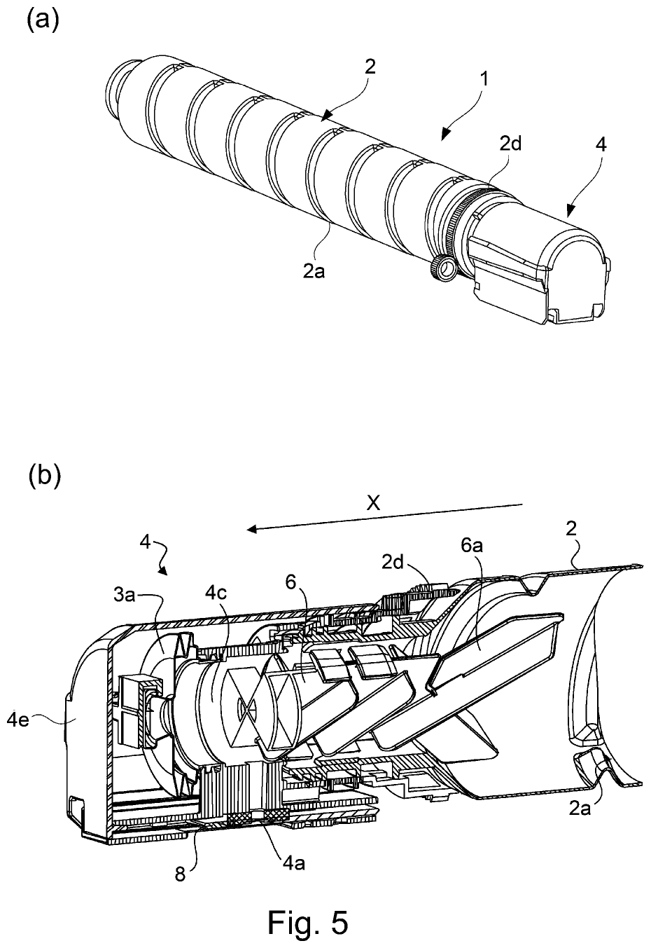

Next, the developer supply device 20 will be described using part (a) of FIG. 3 to FIG. 4 while making reference to FIG. 1. The developer supply device 20 includes, as shown in FIG. 1, a mounting portion 10 in which the developer supply container 1 is mountable and from which the developer supply container 1 is dismountable and a hopper 10a for temporarily storing the developer discharged from the developer supply container 1. The mounting portion 10 is a cylindrical member, in which a space for permitting accommodation of the developer supply container 1 is formed. The developer supply container 1 has a constitution in which the developer supply container 1 is inserted into the mounting portion 10 in an arrow M direction as shown in part (b) of FIG. 3. A longitudinal direction (rotational axis direction of an accommodating portion described later) of the developer supply container 1 substantially coincides with an inserting (insertion) direction of the developer supply container 1. Incidentally, a dismounting direction (removing direction) of the developer supply container 1 from the mounting portion 10 is an opposite direction to arrow M direction of part (b) of FIG. 3.

The mounting portion 10 is, as shown in part (a) of FIG. 3, provided with a rotational direction restricting portion 11 for restricting movement of a flange portion 4 (part (a) of FIG. 5 described later) of the developer supply container 1 in a rotational direction by contact of the rotational direction pressure restricting portion 11 with the flange portion 4.

The mounting portion 10 is provided with a developer receiving opening (developer receiving hole) 13 for receiving the developer discharged from the developer supply container 1 by establishing communication with a discharge opening (discharge hole) 4a of the developer supply container 1. Then, the developer discharged through the discharge opening 4a of the developer supply container 1 is supplied to the hopper 10a through the developer receiving opening 13. The hopper 10a includes a feeding screw 10b for feeding to the developer toward the developing device 201 and a developer sensor 10d for detecting an amount of the developer accommodated in the hopper 10a. The developer discharged from the developer supply container 1 is supplied to the developing device 201 by the hopper 10a.

Further, the mounting portion 10 includes, as an external gear, a driving gear 300 functioning as a driving mechanism as shown in parts (a) and (b) of FIG. 3. To the driving gear 300, a rotational driving force is transmitted from a driving motor 500 (FIG. 4) via a gear train, and the driving gear 300 has a function of imparting the rotational driving force to a gear portion 2d (FIG. 4) of the developer supply container 1 in a state in which the developer supply container 1 is set in the mounting portion 10.

As shown in FIG. 4, the driving motor 500 is controlled by a control device 600 including a CPU (central processing unit), ROM (read only memory), RAM (random access memory) and the like. In the case of this embodiment, the control device 600 controls an operation of the driving motor 500 on the basis of developer remaining amount information inputted from the developer sensor 10d. Incidentally, in the case of the two component developing device, in place of the developer sensor 10d, a magnetic sensor for detecting a toner content in the developer is provided in the developing device 201, and on the basis of a detection result of this magnetic sensor, the operation of the driving motor 500 may only be required to be controlled by the control device 600.

### (Developer Supply Container)

Next, the developer supply container 1 according to First Embodiment will be described with reference to part (a) of FIG. 5 to FIG. 8. The developer supply container 1 includes the accommodating portion 2 which is formed in a hollow cylindrical shape and which is provided with an inside space for permitting accommodation of the developer, and includes the flange portion 4, a feeding member 6 and a pump portion 3a. The accommodating portion 2 is mounted to the flange portion 4 so as to be rotatable relative to the flange portion 4 by being inserted and loose-fitted in the flange portion 4. Further, although illustration is omitted, in the case where the developer supply container 1 is mounted in the developer supply device 20, an upstream side of the accommodating portion 2 with respect to the insertion direction is placed on the mounting portion 10 (part (a) of FIG. 3) so as to be supported from a lower portion with respect to a direction of gravitation. Therefore, the accommodating portion 2 is capable of rotating in a state in which the accommodating portion 2 is inserted relative to the flange portion 4 (specifically the discharging portion 4c).

### (Accommodating Portion)

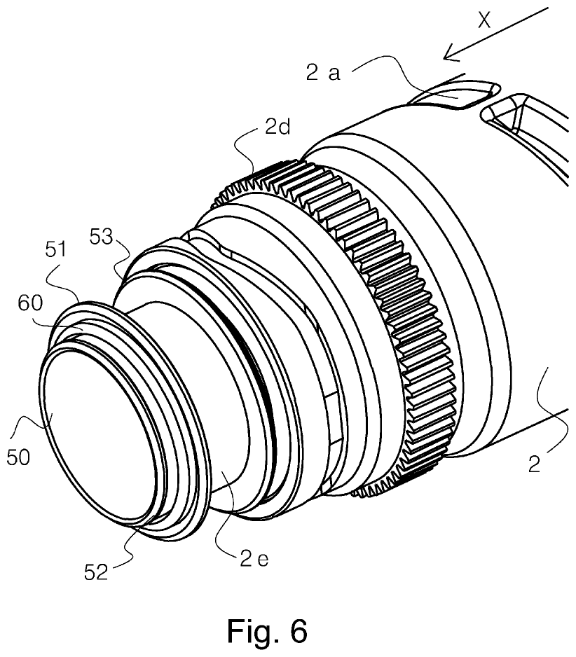

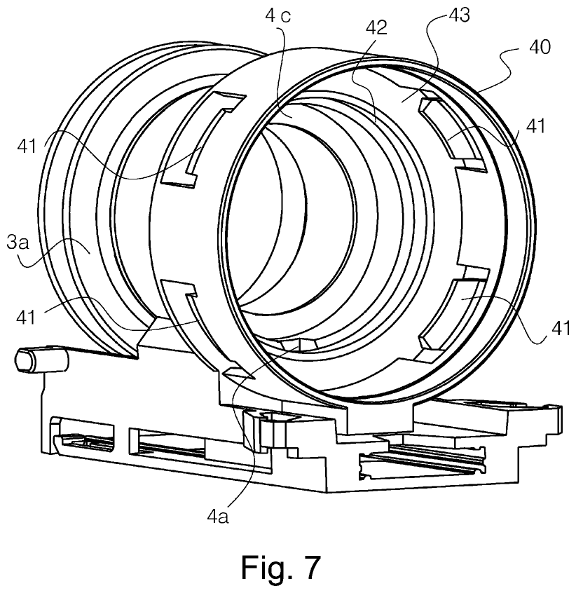

As shown in part (a) of FIG. 5, on an inner surface of the accommodating portion 2, a feeding projection 2a which is helically projected is provided. The feeding projection 2a functions as a mechanism for feeding the accommodated developer toward a discharging portion 4c side (one end portion side, part (b) of FIG. 5) of the flange portion 4 with rotation of the feeding projection 2a itself. Further, as shown in FIG. 6, at an outer periphery of the accommodating portion 2, the gear portion 2d engageable with the driving gear 300 (part (a) of FIG. 3) of the mounting portion 10 is provided. The gear portion 2d receives a driving force from the driving gear 300 engaging with the gear portion 2d. The gear portion 2d has a constitution in which the gear portion 2d is rotatable integrally with the accommodating portion 2. For that reason, by rotation of the accommodating portion 2 rotating with rotation of the gear portion 2d, the developer in the accommodating portion 2 is fed in a feeding direction (arrow X direction) by the feeding projection 2a. Incidentally, the rotational driving force inputted from the driving gear 300 to the gear portion 2d is also transmitted to the pump portion 3a through a reciprocating member 3b (parts (a) and (b) of FIG. 8). The pump portion 3a operates so that an internal pressure of the accommodating portion 2 is alternately switched repetitively between a state in which the internal pressure is lower than ambient pressure and a state in which the internal pressure is higher than the ambient pressure by the driving force received by the gear portion 2d.

As shown in FIG. 6, at one end of the accommodating portion 2 on a downstream side with respect to the insertion direction, a small diameter cylindrical portion 2e provided, as one end portion, with an opening 50 for permitting discharge of the developer toward the discharging portion 4c is formed. In the case of this embodiment, on a free end side of the small diameter cylindrical portion 2e, a projected annular portion 52 is provided so that an outer diameter is larger than an outer diameter of the small diameter cylindrical portion 2e by about 0.3 mm, for example. Further, on an outer peripheral surface of the small diameter cylindrical portion 2e, a first circular rib 51 and a second circular rib 53 which have a ring shape and which project outward in a radial direction crossing the rotational axis direction of the accommodating portion 2 are provided at positions spaced from each other with respect to the longitudinal direction of the developer supply container 2. In other words, in the accommodating portion 2, the small diameter cylindrical portion 2e is formed so as to extend to a side downstream of the first circular rib 51 in the insertion direction of the developer supply container 2, and the projected annular portion 52 is provided at the free end portion of the small diameter cylindrical portion 2e. As described later, the first circular rib 51 restricts motion of the accommodating portion 2 relative to the discharging portion 4c in the rotational axis direction. Further, motion of the accommodating portion 2 in radial direction is restricted by an extended portion (specifically the projected annular portion 52), as a first restricting portion, of the small diameter cylindrical portion 2e and by the second circular rib 53 as a second restricting portion. Incidentally, an outer peripheral portion of the small diameter cylindrical portion 2e may also be used as the first restricting portion without providing the projected annular portion 52.

To the first circular rib 51 as a rib portion, a ring-shaped seal member 60 formed by an elastic member such as an urethane foam is bonded. The accommodating portion 2 is mounted to the flange portion 4 so as to be rotatable relative to the flange portion 4 in a state that the seal member 60 is elastically deformed. As regards the accommodating portion 2, in order to rotate while sliding with the seal member 2, hermetically in the developer supply container 1 is maintained by the seal member 60.

### (Flange Portion)

The flange portion 4 is provided, as shown in part (b) of FIG. 5, with the hollow discharging portion (discharging chamber) 4c for temporarily storing and then discharging the developer which is fed from the accommodating portion 2. The discharging portion 4c is provided with the discharge opening 4a at the bottom thereof. The discharge opening 4a is a small hole provided in a range of 0.05-5 mm in diameter. Incidentally, the shape of the discharge opening 4s is not limited to a circular shape, but may also be any shape having an opening area equal to an opening area of the discharge opening 4a having the above-described diameter. The developer inside the discharging portion 4c passes through a discharge path establishing communication between the discharging portion 4c and the discharge opening 4a and is discharged to an outside of the developer supply container 1 through the discharge opening 4a. At a periphery of the discharge opening 4a, an opening seal which is perforated is provided. The developer supply container 1 is provided with a shutter 8 at the bottom of the discharging chamber 4c so as to sandwich the opening seal between the shutter 8 and the discharging portion 4c. The shutter 8 is configured so as to close the discharge opening 4a in a state in which the developer supply container 1 is not mounted in the developer supply device 20 and so as to open the discharge opening 4a in a state in which the developer supply container 1 is mounted in the developer supply device 20. That is, the shutter 8 is capable of opening and closing the discharge opening 4a with a mounting and dismounting operation of the developer supply container 1 relative to the developer supply device 20.

The flange portion 4 is substantially non-rotatable in response to mounting of the developer supply container 1 in the mounting portion 10. Specifically, in order to prevent the flange portion 4 itself from rotating in the rotational direction of the accommodating portion 2, the above-described rotational direction restricting portion 11 is provided (part (a) of FIG. 3). Accordingly, in the state in which the developer supply container 1 is mounted in the mounting portion 10, the discharging portion 4c of the flange portion 4 is also in a state in which rotation thereof in the rotational direction of the accommodating portion 2 is substantially prevented (but movement thereto to the extent of play is permitted). On the other hand, the accommodating portion 2 is rotatable in a developer supplying step without being subjected to restriction of rotation in the rotational direction thereof.

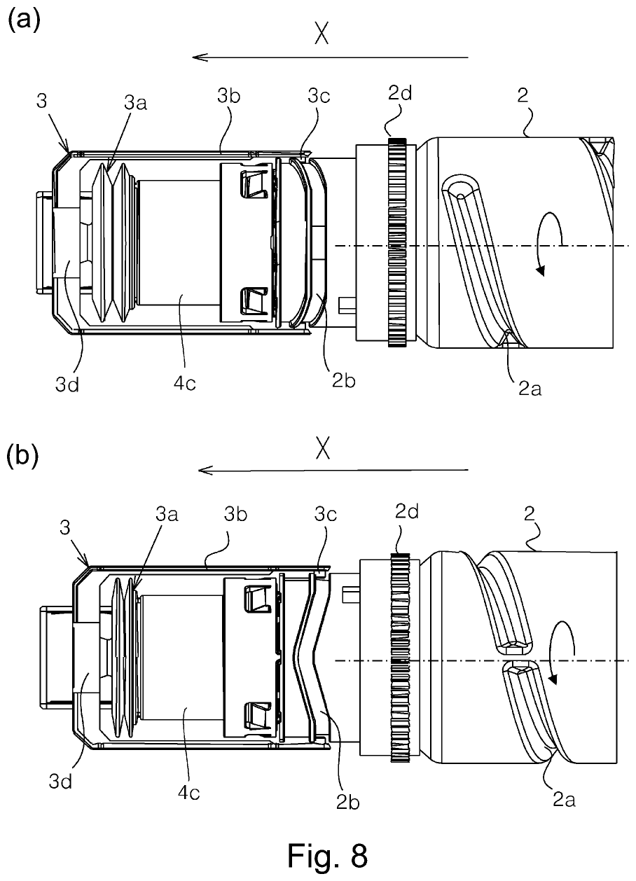

As shown in FIG. 7, to the flange portion 4, the pump portion 3a is mounted. The flange portion 4 is configured so that the accommodating portion 2 is mountable on a side opposite from the pump portion 3a. Specifically, in the order from an upstream side of the discharging portion 4c with respect to the insertion direction, as receiving portions, an upstream cylindrical portion (second cylindrical portion) 40 and a downstream cylindrical portion (first cylindrical portion) 42 which are provided for permitting mounting of the accommodating portion 2 through loose fitting are formed. The downstream cylindrical portion 42 includes a seal nipping portion 43 capable of compressing and nipping the seal member 60 between itself and the first circular rib 51. On the other hand, the upstream cylindrical portion 40 is provided with a plurality of locking claws 41, each projecting toward an inside with respect to the radial direction. Mounting of the flange portion 4 and the accommodating portion 2 will be described later.

### (Feeding Member)

As shown in part (b) of FIG. 5, in the accommodating portion 2 a plate-like feeding member 6 for feeding the developer, fed from the inside of the accommodating portion 2 by a helical projection (feeding projection) 2a, toward the flange portion 4 (discharging chamber 4c) is provided. This feeding member 6 is provided so as to divide a part of a region of the accommodating portion 2 into substantially two portions and is configured to rotate together integrally with the accommodating portion 2. Further, this feeding member 6 is provided with a plurality of inclined ribs 6a each inclined toward the flange portion 4 side with respect to the rotational axis direction of the accommodating portion 2 on each of opposite surfaces thereof. The developer fed by the feeding projection 2a is raised from below toward above with respect to a vertical direction by this plate-like feeding member 6 in interrelation with rotation of the accommodating portion 2. Thereafter, with further rotation of the accommodating portion 2, the developer is delivered toward the flange portion 4 by the inclined rib 6a. In this constitution, this inclined rib 6a is provided on the opposite surfaces of the feeding member 6 so that the developer is sent to the discharging portion 4c every half rotation of the accommodating portion 2.

### (Pump Portion)

In this embodiment, as described above, in order to stably discharge the developer through a small discharge opening 4a, the above-described pump portion 3a is provided at a part of the developer supply container 1. The pump portion 3a is a variable-volume pump in which a volume thereof is variable and which is made of a resin material. Specifically, as the pump portion 3a, a pump comprising a bellows-like expansion and contraction member which is capable of expansion and contraction is employed. Specifically, a bellows-like pump is employed, and a plurality of “mountain-fold” portions and “valley-fold” portions are alternately formed periodically.

The developer supply container 1 is provided with a cam mechanism functioning as a drive conversion mechanism for converting a rotational driving force, for rotating the accommodating portion 2, received by the gear portion 2d into a force in a direction in which the pump portion 3a is reciprocated. In this embodiment, a constitution in which by converting the rotational driving force received by the gear portion 2d into a reciprocating force on the developer supply container 1 side, a driving force for rotating the accommodating portion 2 and a driving force for reciprocating the pump portion 3a are received by a single drive-inputting portion (gear portion 2d) is employed.

Here, part (a) of FIG. 8 is a partial view of the pump portion 3a in a state in which the pump portion 3a is expanded to the maximum in use, and part (b) of FIG. 8 is a partial view of the pump portion 3a in a state in which the pump portion 3a is contracted to the maximum in use. As shown in parts (a) and (b) of FIG. 8, as an intervening member for converting the rotational driving force into the reciprocating force of the pump portion 3a, a reciprocating member 3b is used. Specifically, the gear portion 2a receiving the rotational driving force from the driving gear 300 and a cam groove 2b provided with a groove extending through one full circumference are rotated. With this cam groove 2b, a reciprocating member engaging projection 3c projected partly from the reciprocating member 3b engages. Further, a rotational direction of the reciprocating member 3b is restricted by a protective cover 4e (part (b) of FIG. 5) so that the reciprocating member 3b itself does not rotate in the rotational to direction of the accommodating portion 2. The reciprocating member 3b reciprocates along the groove of the cam groove 2b (in an arrow X direction or an opposite direction) by being restricted in rotational direction thereof. That is, the cam groove 2b is rotated by the rotational driving force inputted from the driving gear 300, so that the reciprocating member engaging projection 3c reciprocates in the arrow X direction or the opposite direction. Correspondingly, the pump portion 3a alternately repeats an expanded state (part (a) of FIG. 8) and a contracted state (part (b) of FIG. 8) and thus a volume of the developer supply container 1 is made variable.

By this expansion and contraction operation of the pump portion 3a, a pressure in the developer supply container 1 is changed, and discharge of the developer is carried out by utilizing the pressure. Specifically, when the pump portion 3a is contracted, in side of the developer supply container 1 is in a pressed state, so that the developer is discharged through the discharge opening 4a in a manner such that the developer is pushed out by the pressure. Further, when the pump portion 3a is expanded, the inside of the developer supply container 1 is in a reduced pressure state, so that outside air is taken in from the outside of the developer supply container 1 through the discharge opening 4a. The developer in the neighborhood of the discharge opening 4a is loosened by the outside air taken in through the discharge opening 4a, so that subsequent discharge is smoothly carried out. The developer is discharged through the discharge opening 4a in accordance with a pressure difference between the inside pressure and the ambient pressure (outside pressure) of the developer supply container 1 generated by repetitive execution of the above-described expansion and contraction operation by the pump portion 3a.

Incidentally, a discharging method of the developer from the developer supply container 1 is not limited to the expansion and contraction of the to above-described pump portion 3a. For example, the developer supply container 1 may also have a structure in which the developer supply container 1 is not provided with the pump portion and the diameter of the discharge opening 4a is made larger than an opening area and in which the developer deposited on the discharging chamber (discharging portion) 4c is discharged by gravitation. Further, the developer supply container 1 may also have a constitution in which the pump portion is not provided and the developer is sent to a discharging path by a rotatable member 6b provided just above an inlet of the discharging path.

### (Material of Developer Supply Container)

In this embodiment, as described above, the constitution in which the developer is discharged through the discharge opening 4a by changing the volume of the inside of the developer supply container 1 by the pump portion 3a is employed. Therefore, as a material of the developer supply container 1, a material having rigidity to the extent that a resultant developer supply container is largely collapsed due to a volume changer or the developer supply container is not expanded may preferably be employed. In this embodiment, the developer supply container 1 communicates with the outside only through the discharge opening 4a during the discharge of the developer and thus has a constitution in which the developer supply container 1 is hermetically sealed from the outside except for the discharge opening 4a. that is, a constitution in which the developer is discharged through the discharge opening 4a by decreasing and increasing the volume of the developer supply container 1 by the pump portion 3a is employed, and therefore, hermetically to the extent that a stable discharging performance is required. Therefore, in this embodiment, a material of the accommodating portion 2 is PET resin, a material of the flange portion 4 is polystyrene resin, and a material of the pump portion 3a is polypropylene resin.

Incidentally, as regards the materials used, when the materials of the accommodating portion 2 and the flange portion 4 are capable of withstanding the volume change, for example, it is possible to use other resin materials such as ABS (acrylonitrile-butadiene-styrene copolymer), polyester, polyethylene and polypropylene. As regards the material of the pump portion 3a, the material may only be required that the material exhibits an expansion and contraction function and is capable of changing the volume of the developer supply container 1 by the volume change thereof. For example, the pump portion 3a may also be formed in a thin film of ABS, polystyrene, polyester, polyethylene or the like, or it is also possible to use a rubber or another material having expansion and contraction properties.

Next, a manner of mounting the above-described accommodating portion 2 and the flange portion 4 will be described with reference to parts (a) and (b) of FIG. 9. The accommodating portion 2 is rotatably loose-fitted in the discharging portion 4c of the flange portion 4 on one end side of the discharging portion 4c. In the case of this embodiment, the downstream cylindrical portion 42 is formed in an inner diameter of “φ38 mm (+0.10/0)”, and the projected annular portion 52 is formed in an outer diameter of “φ38 mm (−0.02/−0.12)”, so that the downstream cylindrical portion 42 and the projected annular portion 52 is in a loose fitting relationship. Further, the upstream cylindrical portion 40 is formed in an inner diameter of “φ46 mm (+0.10/0)”, and the second circular rib 53 is formed in an outer diameter of “φ46 mm (−0.01/−0.12)”, so that the upstream cylindrical portion 40 and the second circular rib 53 are in a loose fitting relationship. This is for the purpose of rotating the accommodating portion 2 smoothly even when deviation between an inner diameter circle center of the upstream cylindrical portion 40 and an outer diameter circle center of the second circular rib 53 occurs due to component part variation or the like. Further, as regards a length (thickness) of each of the projected annular portion 52 and the second circular rib 53 of the accommodating portion 2, these portions are formed so that a contact width (sliding width) is, for example, “0.5 mm”, with the result that a load when the accommodating portion 2 is rotated is reduced.

Incidentally, in this embodiment, with respect to the rotational axis direction of the accommodating portion 2, a distance (L1 in part (b) of FIG. 9) between a first contact portion P1 where the downstream cylindrical portion 42 and the projected annular portion 52 contact each other and a second contact portion P2 where the upstream cylindrical portion 40 and the second circular rib 53 contact each other was “15 mm”. Further, in a state in which the accommodating portion 2 is not inclined relative to the discharging portion 4c, a gap by the loose fitting may preferably be set at 0.30 mm or less.

In a state in which the accommodating portion 2 is loose-fitted in the discharging portion 4c, movement of the accommodating portion 2 in the rotational axis direction is restricted by the discharging portion 4c. Specifically, as shown in parts (a) and (b) of FIG. 9, the first circular rib 51 of the accommodating portion 2 is locked by the locking claws 41 formed inside the upstream cylindrical portion 40 of the discharging portion 4c. Then, the elastic seal member 60 is provided on a side opposite from a surface side of the first circular rib 51 locked by the locking claws 41, so that the seal member 60 is compressed by being nipped by the first circular rib 51 and the seal nipping portion 43 of the discharging portion 4c. During rotation of the accommodating portion 2, the seal member 60 slides on the seal nipping portion 43 of the discharging portion 4c. Thus, the accommodating portion 2 is prevented from causing whirling motion by a seal repelling force generated by abutting and compressing the seal member 60 against the seal nipping portion 43.

Incidentally, in the case of this embodiment, in the state in which the accommodating portion 2 is not inclined, a seal compression amount is set so that the thickness thereof (E1 in the figure) after compression is, for example, “2.2 mm” relative to the thickness thereof, after the compression.

On the other hand, as regards restriction of movement of the accommodating portion 2 in the radial direction, in the neighborhood of the opening 50 and on a side downstream of the seal member 60 with respect to the insertion direction, an inner peripheral surface of the downstream cylindrical portion 42 and an outer peripheral surface of the projected annular portion 52 contact each other. In addition, on a side upstream of the seal member 60 with respect to the insertion direction, an inner peripheral surface of the upstream cylindrical portion 40 and an outer peripheral surface of the second circular rib 53 contact each other. Thus, the restriction of the movement of the accommodating portion 2 is realized. That is, the accommodating portion 2 is contacted obliquely to the discharging portion 4c at two distant positions with respect to the insertion direction, so that the movement of the accommodating portion 2 in the radial direction is restricted.

In the case of this embodiment, as can be understood from parts (a) and (b) of FIG. 9, the seal member 60 is disposed between the projected annular portion 52 and the second circular rib 53 (specifically within a range shown by L1 in part (b) of FIG. 9). The seal member 60 is caused so that the seal member 60 can be disposed at the position, whereby it is possible to suppress deformation of the seal member 60 due to rotation of the accommodating portion 2 in a state in which the accommodating portion 2 is inclined relative to the discharging portion 4c.

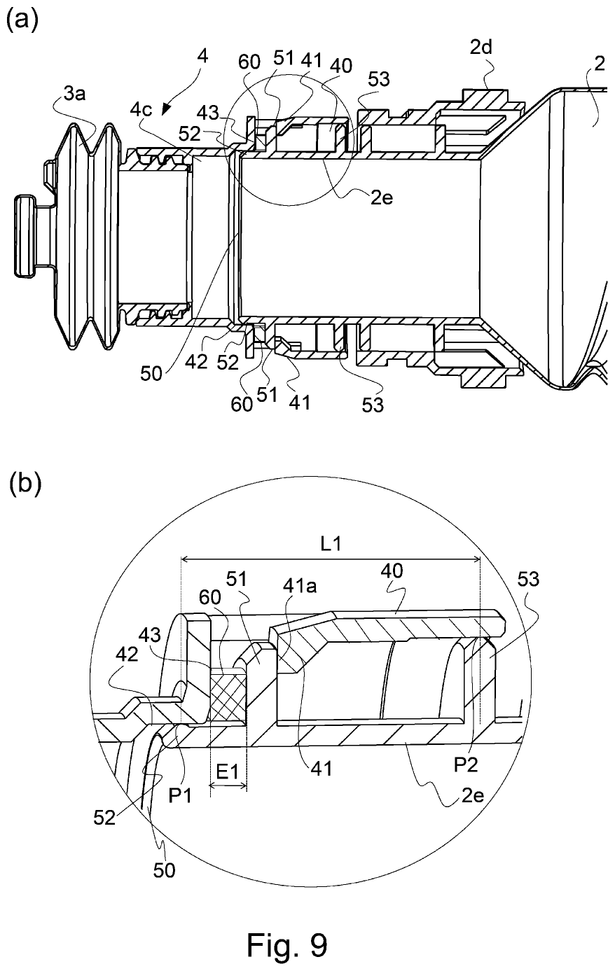

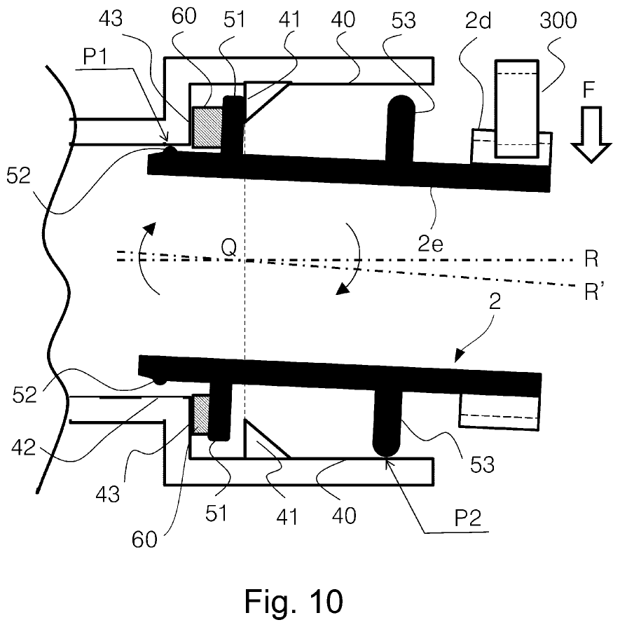

In the following, this point will be described with reference to FIG. 10.

As shown in FIG. 10, the accommodating portion 2 is rotated by transmission of the rotational drive (rotatable driving force) from the driving gear 300 to the gear portion 2d provided at the outer periphery of the accommodating portion 2. When the accommodating portion 2 is rotated, in the accommodating portion 2, a radial load is capable of generating in the radial direction (specifically an arrow F direction in FIG. 10) due to a rotational load by the driving gear 300. An upstream side of the accommodating portion 2 with respect to the insertion direction is mounted in the mounting portion 10, and therefore, when the radial load generates, the accommodating portion 2 is inclined in the arrow F direction in FIG. 10 relative to the discharging portion 4c by the influence thereof, so that the whirling motion can occur not a little. The rotational load of the accommodating portion 2 is not constant but fluctuates, and therefore, a degree of the whirling motion is also not constant. Incidentally, herein, the state in which the accommodating portion 2 is inclined relative to the discharging portion 4c refers to a state in which a rectilinear line R passing through a radial center of the downstream cylindrical portion 42 (and the upstream cylindrical portion 40) and a rotational axis R′ of the accommodating portion 2 cross each other. On the other hand, a state in which the accommodating portion 2 is not inclined relative to the discharging portion 4c refers to a state in which the above-described center line R and the rotational axis R′ substantially coincide with each other (do not cross each other).

Further, in the case of this embodiment, when the accommodating portion 2 is inclined by a radial load F, the first circular rib 51 of the accommodating portion 2 is abutted against and contacted to the locking claws 41 on the driving gear 300 side. Therefore, accommodating portion 2 is inclined while being rotated with, as a supporting point, a contact portion between the first circular rib 51 and the locking claw 41. Then, on an opposite side where the accommodating portion 2 is rotated (moved) 180° from the driving gear 300 in the circumferential direction thereof, the second circular rib 53 abuts and contacts the second contact portion P2 of the inner peripheral surface of the upstream cylindrical portion 40. On the other hand, on the driving gear 300 side, the projected annular portion 52 abuts and contacts the first contact portion P1 of the inner peripheral surface of the downstream cylindrical portion 42, so that the accommodating portion 2 is not inclined further. When the accommodating portion 2 is inclined, the pressure applied to the seal member 60 by the first circular rib 51 is different between the driving gear 300 side and the opposite side from the driving gear 300 side. A difference, in pressure applied to the seal member 60 by the first circular rib 51, between the driving gear 300 side and the opposite side from the driving gear 300 side increases with an increasing degree of the inclination of the accommodating portion 2.

In this embodiment, first, the inclination of the accommodating portion 2 is suppressed by the projected annular portion 52 and the second circular rib 53. Then, as described above, when the inclination of the accommodating portion 2 is restricted at different positions (P2, P1) spaced from each other with respect to the rotational axis direction, an oscillation center Q of the accommodating portion 2 is formed between the projected annular portion 52 and the second circular rib 53 (within the range shown by L1 in part (b) of FIG. 9). Thus, the seal member 60 is disposed so as to be close to the oscillation center Q. As a result, even when the accommodating portion 2 is inclined (oscillated), pressure exerted on the seal member in the rotational axis direction by the accommodating portion 2 does not fluctuate largely compared with before the accommodating portion 2 is inclined. Accordingly, the pressure exerted on the seal member in the rotational axis direction does not fluctuate largely with respect to the circumferential direction, so that the seal member 60 cannot locally deform largely.

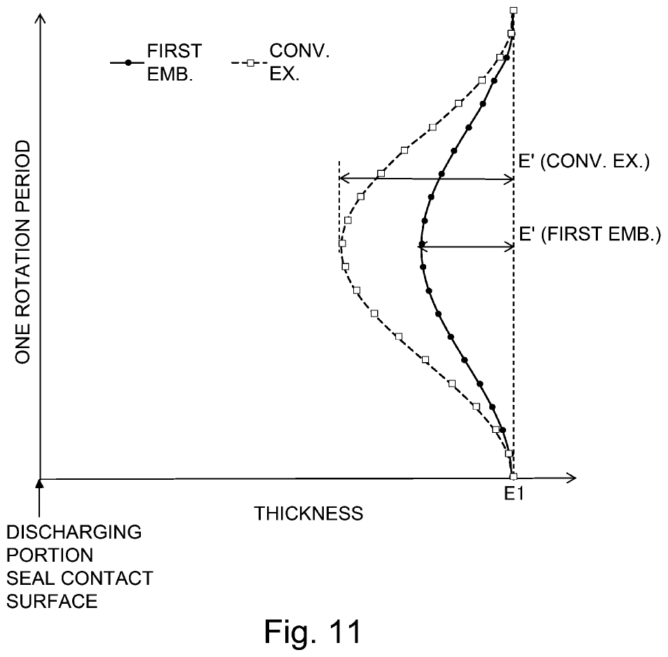

Here, in this embodiment (“FIRST EMB.”) and a conventional example (“CONN. EX.”), a comparison result of thicknesses of the seal members 60 in the case where the accommodating portions 2 are rotated in the inclined state is shown in FIG. 11. In the conventional example, compared with this embodiment, a constitution in which the accommodating portion 2 is provided with the first circular rib 51 but not provided with the projected annular portion 52 and the second circular rib 53 is employed. Incidentally, in FIG. 11, the ordinate represents one rotation (cyclic) period of the accommodating portion 2, and the abscissa represents a seal thickness of the seal member 60 at an arbitrary seal contact position.

As can be understood from FIG. 11, when the accommodating portion 2 causes the whirling motion, every rotation of the accommodating portion 2, the seal member 60 repeats displacement in a direction of further compressing the seal member 60. For this reason, the seal member 60 repeats excessive compression in a compression amount which is a desired compression amount or more. The excessive compression amount was represented by E in FIG. 11. In this embodiment, compared with the conventional example, the excessive compression amount was able to be suppressed to 50%. That is, it was possible to suppress the deformation of the seal member 60 due to the rotation of the accommodating portion 2 in the inclined state relative to the discharging portion 4c.

As described above, according to this embodiment, in the inclination of the accommodating portion 2 can be reduced by disposing the radial restricting portions (engaging portions) at positions upstream and downstream of the seal member 60 with respect to the insertion direction of the accommodating portion 2. Further, a distance between the restricting portions can be made long, so that the seal member 60 can be disposed so as to be close to the oscillation center Q of the accommodating portion 2. As a result, the pressure applied to the seal member 60 in the rotational axis direction by the accommodating portion 2 cannot fluctuate largely compared with before the accommodating portion 2 is inclined, so that the seal member 60 cannot be largely deformed locally. Thus, in this embodiment, while suppressing the whirling motion of the accommodating portion 2 by the seal member 60, deformation of the seal member 60 due to the rotation of the accommodating portion 2 in the inclined state relative to the discharging portion 4c can be suppressed by a simple constitution.

### Second Embodiment

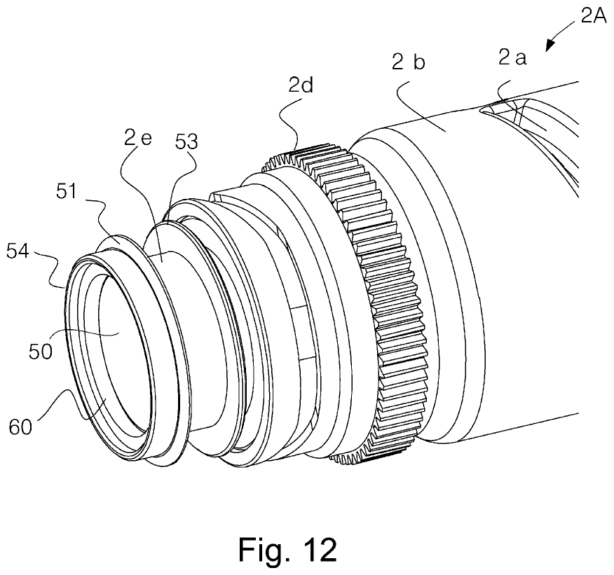

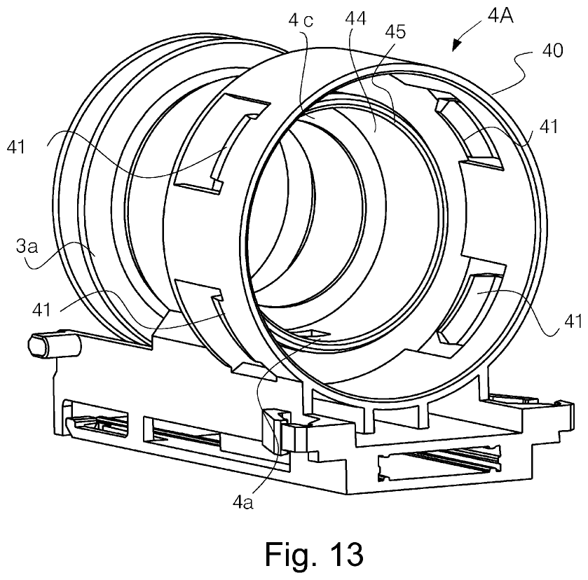

A developer supply container of Second Embodiment will be described with reference to FIG. 12 to part (b) of FIG. 14. The developer supply container of Second Embodiment includes an accommodating portion 2A which is formed in a hollow cylindrical shape and which accommodates the developer therein, and includes a flange portion 4A. Also in Second Embodiment, the feeding member 6 and the pump portion 3a are provided, but these are similar to those in the above-described First Embodiment, and therefore are omitted from illustration and description. Further, constituent elements which are the same as those in the above-described First Embodiment will be omitted from description or briefly described by adding the same reference numerals or symbols thereto.

### (Accommodating Portion)

As shown in FIG. 12, at one end of the accommodating portion 2A on a downstream side with respect to the insertion direction, a small diameter cylindrical portion 2e provided, with an opening 50 for permitting discharge of the developer toward the discharging portion 4c is formed. On an outer peripheral surface of the small diameter cylindrical portion 2e, a first circular rib 51 and a second circular rib 53 which have a ring shape and which project outward in a radial direction crossing the rotational axis direction of the accommodating portion 2A are provided at positions spaced from each other with respect to the longitudinal direction of the developer supply container.

To the first circular rib 51, a ring-shaped seal member 60 formed by an elastic member such as an urethane foam is bonded. Further, in this embodiment, a free end cylindrical portion 54 having an inner diameter larger than an outer diameter of the small diameter cylindrical portion 2e so as to surround the seal member 60. In other words, in the accommodating portion 2A, the free end cylindrical portion 54 is formed so as to project toward a side downstream of the first circular rib 51 with respect to the insertion direction, and the seal member 60 is provided at an inner periphery of the free end cylindrical portion 54.

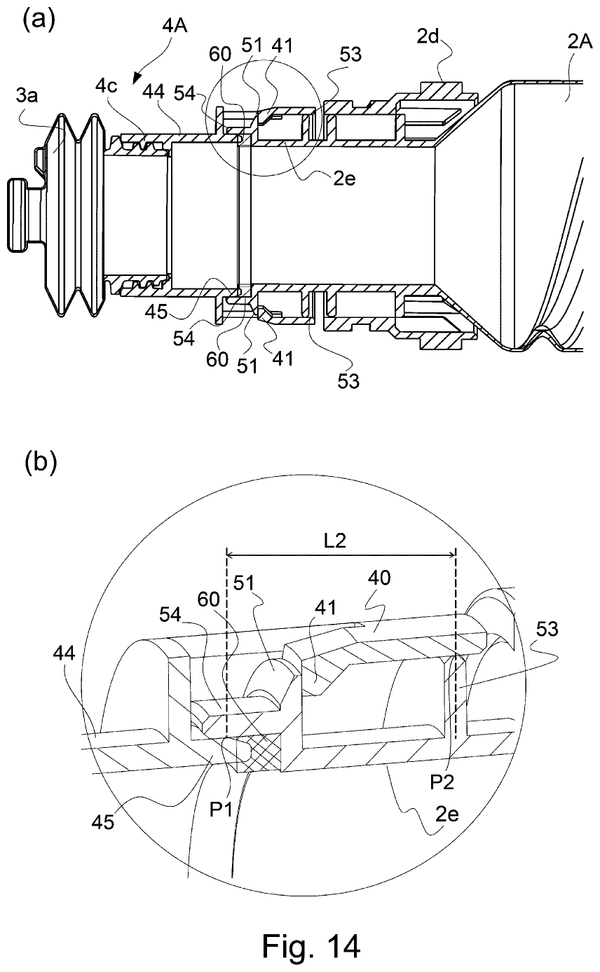

Also in this embodiment, the accommodating portion 2A is mounted to the flange portion 4 so as to be rotatable relative to the flange portion 4A (FIG. 13) in a state that the seal member 60 is elastically deformed. As regards the accommodating portion 2, in order to rotate while sliding with the seal member 2, hermetically in the developer supply container 1 is maintained by the seal member 60. Further, in this embodiment, as described later motion of the accommodating portion 2A in the rotational axis direction is restricted by the first circular rib 51, and motion of the accommodating portion 2A in the radial direction is restricted by the free end cylindrical portion 54 as a first restricting portion and the second circular rib 53 as a second restricting portion.

### (Flange Portion)

The flange portion 4A is provided, as shown in FIG. 13, with the hollow discharging portion (discharging chamber) 4c for temporarily storing and then discharging the developer which is fed from the accommodating portion 2A. The discharging portion 4c is provided with the discharge opening 4a at the bottom thereof.

The flange portion 4A is configured so that the accommodating portion 2A is mountable on a side opposite from the pump portion 3a. Specifically, in the order from an upstream side of the discharging portion 4c with respect to the insertion direction, as receiving portions, an upstream cylindrical portion (second cylindrical portion) 40 and a downstream cylindrical portion 44 which are provided for permitting mounting of the accommodating portion 2A through loose fitting are formed. The downstream cylindrical portion 44 includes a seal abutment portion 45 for compressing and nipping the seal member 60 between itself and the first circular rib 51 (part (b) of FIG. 14). The seal abutment portion (first cylindrical portion) 45 is provided so as to project from an end portion of the downstream cylindrical portion 44 in the opposite direction to the insertion direction so that the seal abutment portion 45 enters the upstream cylindrical portion 40. On the other hand, the upstream cylindrical portion 40 is provided with a plurality of locking claws 41, each projecting toward an inside with respect to the radial direction.

The accommodating portion 2A is rotatably loose-fitted in the discharging portion 4c of the flange portion 4A on one end side of the discharging portion 4c. In the case of this embodiment, as shown in parts (a) and (b) of FIG. 14, the downstream cylindrical portion 44 and the free end cylindrical portion 54 are in a loose fitting relationship, and the upstream cylindrical portion 40 and the second circular rib 53 are in the loose fitting relationship.

In a state in which the accommodating portion 2A is loose-fitted in the discharging portion 4c, movement of the accommodating portion 2A in the rotational axis direction is restricted by the discharging portion 4c by locking of the first circular rib 51 by the locking claws 41. Then, the elastic seal member 60 is provided on a side opposite from a surface side of the first circular rib 51 locked by the locking claws 41, so that the seal member 60 is compressed by being nipped by the first circular rib 51 and the seal abutment portion 45. During rotation of the accommodating portion 2A, the seal member 60 slides on the seal abutment portion 45. Thus, the accommodating portion 2A is prevented from causing whirling motion by a seal repelling force generated by abutting and compressing the seal member 60 against the seal abutment portion 45.

On the other hand, as regards restriction of movement of the accommodating portion 2A in the radial direction, in the neighborhood of the opening 50 and on a side downstream of the seal member 60 with respect to the insertion direction, an outer peripheral surface of the seal abutment portion 45 and an inner peripheral surface of the free end cylindrical portion 54 contact each other. In addition, on a side upstream of the seal member 60 with respect to the insertion direction, an inner peripheral surface of the upstream cylindrical portion 40 and an outer peripheral surface of the second circular rib 53 contact each other. Thus, the restriction of the movement of the accommodating portion 2A is realized. That is, the accommodating portion 2A is contacted obliquely to the discharging portion 4c at two distant positions with respect to the insertion direction, so that the movement of the accommodating portion 2A in the radial direction is restricted.

That is, in the case of this embodiment, when the accommodating portion 2A is inclined depending on a radial load F by the driving gear 300 (FIG. 10), the first circular rib 51 of the accommodating portion 2A is abutted against and contacted to the locking claws 41 on the driving gear 300 side. Therefore, accommodating portion 2A is inclined while being rotated with, as a supporting point, a contact portion between the first circular rib 51 and the locking claw 41. Then, on an opposite side where the accommodating portion 2 is rotated (moved) 180° from the driving gear 300 in the circumferential direction thereof, the second circular rib 53 abuts and contacts the second contact portion P2 of the inner peripheral surface of the upstream cylindrical portion 40. On the other hand, on the driving gear 300 side, the inner peripheral surface of the free end cylindrical portion 54 abuts and contacts the first contact portion P1 with the outer peripheral surface of the seal abutment portion 45, so that the accommodating portion 2A is not inclined further.

As described above, when the inclination of the accommodating portion 2 is restricted at different positions (P2, P1) spaced from each other with respect to the rotational axis direction, an oscillation center of the accommodating portion 2A is formed between the free end cylindrical portion 54 and the second circular rib 53 (within a range shown by L2 in part (b) of FIG. 14). Thus, the seal member 60 is disposed between the free end cylindrical portion 54 and the second circular rib 53 so as to be close to the oscillation center of the accommodating portion 2A. As a result, even when the accommodating portion 2A is inclined (oscillated), pressure exerted on the seal member in the rotational axis direction by the accommodating portion 2A does not fluctuate largely compared with before the accommodating portion 2A is inclined. Accordingly, the pressure exerted on the seal member in the rotational axis direction does not fluctuate largely with respect to the circumferential direction, so that the seal member 60 cannot locally deform largely.

As described above, also by this embodiment, an effect such that while suppressing the whirling motion of the accommodating portion 2A by the seal member 60, deformation of the seal member 60 due to the rotation of the accommodating portion 2A in the inclined state relative to the discharging portion 4c can be suppressed by a simple constitution is achieved.

### Other Embodiments

Incidentally, the developer supply container 1 of this embodiment may also be a developer supply container 1 in which the pump portion 3a is not provided. In this case, constituent elements other than the pump portion 3a may also be similar to those in the above-described embodiments. As regards the feeding of the developer in the developer supply container 1, a constitution in which the developer is fed toward the discharging portion 4c by the accommodating portion 2 and the feeding member 6 may also be employed.

According to the above-described embodiment, while suppressing the whirling motion of the accommodating portion by the seal member, deformation of the seal member due to rotation of the accommodating portion in the state in which the accommodating portion is inclined relative to the discharging portion can be suppressed by a simple constitution.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-162136 filed on Aug. 30, 2018, which is hereby incorporated by reference herein in its entirety.

What is claimed is:

1. A developer supply container mountable in and dismountable from a developer supply device, said developer supply container comprising:
an accommodating portion including one end portion provided with an opening, wherein a developer accommodated in said accommodating portion is fed toward said one end portion by rotation of said accommodating portion;
a discharging portion including a receiving portion into which said one end portion of said accommodating portion is inserted so as to be rotatable relative to said accommodating portion, and a discharge opening configured to to discharge the developer supplied through said opening of said accommodating portion, wherein said accommodating portion is nonrotatably mounted to the developer supply device;
a sealing member configured to seal a space between said one end portion and said receiving portion by being elastically compressed;
a first restricting portion provided on said one end portion and configured to restrict movement of said accommodating portion in a radical direction crossing a rotational axis direction of said accommodating portion in contact with said receiving portion; and
a second restricting portion contactable to said receiving portion on a side upstream of said first restricting portion with respect to an inserting direction of said one end portion and configured to restrict the movement of said accommodating portion in the radial direction,
wherein said seal member is provided between said first restricting portion and said second restricting portion with respect to the rotational axis direction.

2. A developer supply container according to claim 1, wherein said discharging portion includes a retaining portion configured to lock a part of said accommodating portion in said receiving portion so that said one end portion is prevented from disengaging from said receiving portion.

3. A developer supply container according to claim 2, wherein said accommodating portion is provided with a rib portion projecting from an outer peripheral surface in the radial direction at said one end portion,
wherein said retaining portion locks said rib portion, and
wherein said seal member is compressed in the rotational axis to direction by side rib portion locked by said retaining portion.

4. A developer supply container according to claim 3, wherein said seal member is provided on said rib portion.

5. A developer supply container according to claim 1, wherein said accommodating portion includes, on an outer peripheral surface thereof, a gear portion configured to receive a rotational driving force from an external gear.

6. A developer supply container according to claim 1, wherein said receiving portion includes a first cylindrical portion and a second cylindrical portion larger in inner diameter than said first cylindrical portion which are disposed in a named order from a downstream side with respect to the inserting direction,
wherein said first restricting portion is extended from a free end of said one end portion in the inserting direction so as to contact said first cylindrical portion,
wherein said second restricting portion is projected from an outer peripheral surface of said one end portion in the radial direction so as to contact said second cylindrical portion, and
wherein said seal member is provided, with respect to the rotational axis direction, between a first contact portion where said first restricting portion and said first cylindrical portion contact each other and a second contact portion where said second restricting portion and said second cylindrical portion contact each other.

7. A developer supply container according to claim 6, wherein said first to restricting portion and said second restricting portion are provided between said first restricting portion and said first cylindrical portion with a gap and between said second restricting portion and said second cylindrical portion with a gap, respectively.

8. A developer supply container according to claim 7, wherein said of the gaps is set at 0.3 mm or less.
